(19) United States
(12) Patent Application Publication
(10) Pub. No.: US 2020/0309989 A1
(43) Pub. Date: Oct. 1, 2020

(54) WELLBORE AND RESERVOIR LOGGING-MAPPING-CHARACTERIZATION SYSTEM

(71) Applicant: L. ZANE SHUCK, MORGANTOWN, WV (US)

(72) Inventor: L. ZANE SHUCK, MORGANTOWN, WV (US)

(21) Appl. No.: 16/365,873

(22) Filed: Mar. 27, 2019

(51) Int. Cl. G01V 8/02; G01V 3/02; E21B 47/01; E21B 47/00; E21B 47/12; H04N 5/225; H04N 7/18

(52) U.S. Cl. CPC G01V 8/02; G01V 3/02; E21B 47/011; H04N 2005/2255; E21B 47/12; H04N 5/2252; H04N 7/181; E21B 47/0002

(57) ABSTRACT

A horizontal wellbore logging, mapping and characterization system uses new variables of in situ stress fields, natural vertical fracture systems, with sensors and transducers, to acquire data for directional drilling and well completion design. System may be operated from end of coiled tubing base station, or conduct autonomous measurements and experiments. It constitutes a downhole smart system utilizing AI, and robotic means for mechanical property, reservoir, and structural characterizations. Video cameras front, side, and rear looking with LED lights allow observation of experiments in real time, and entire lateral wellbore mapping of natural vertical fracture systems to design and implement new drilling and open-hole well completion methodologies without use of mud, water, cement, or steel pipe cemented in the laterals. The characterizations and models developed following the logging process can be used interactively in the drilling and completion of oil and gas wells.

### CROSS-REFERENCE TO RELATED APPLICATION

“Not Applicable”

### BACKGROUND

The drilling of shale wells throughout the world to recover oil or gas has mushroomed since around 2010, when directional drilling matured and long horizontal boreholes (laterals) through the pay zones have gone from 5,000′ to 20,000′ or more in length. These rapid technology achievements translated into hopefully extremely profitable ventures. Now though, after a few years of production serious problems have emerged that have resulted in departure of investors on Wall Street, along with serious technical issues. Perhaps, most notable is that after two years, the production drops by 80% and estimated total recovery for oil is 8% and gas is below 20% instead of the 60% norm. This disaster merits major attention for the U. S. and the world, since largely the same U. S. technology is used throughout the world. Thus, diagnosis of the problems and inventing better technology is top priority.

### BRIEF DESCRIPTION OF THE DRAWINGS

The aforementioned and other aspects, features and advantages can be more readily understood from the following detailed description with reference to the accompanying drawings wherein:

FIG. 1 shows the major components and functionality the Wellbore-Reservoir-Logging-Mapping-Characterization System.

FIG. 2 shows the major components and functionality of the Wellbore-Reservoir-Logging-Mapping-Characterization System with Research Console Modules for In Situ Stress and Structure Properties.

### DETAILED DESCRIPTION OF THE INVENTION

Significant Variables for Drilling Horizontal Oil and Gas Wells

The major shale oil and gas resources are located usually at depths below 6,000′, which brings into play a different set of variables, from those above 5,000′. The major impact is in situ stress fields on the lateral wellbores. The implications of some of the variables identified herein are probably of little significance or concern to those drilling the lateral boreholes in the shale, or fracking wells, except as they may pertain to cave-ins. However, the joints or natural vertical fractures (“NVFs”) are as important as any variable associated with oil and gas extraction technology using horizontal boreholes, and the in situ stress fields are a close second, if not first or most significant variable of importance. NVFs can now be measured in lateral wellbores, but today there are no means of directly measuring all the variables associated with in situ stress fields so urgently needed just to make routine competent engineering calculations and designs. While the NVFs obviously play at least some minor role in the classical sandstone and limestone reservoirs, where radial flow is a reasonable assumption, they are a primary, strong variable of top priority in the impermeable, nonporous shales with nano order of permeabilities. This is because the NVFs are the only viable oil or gas conduit of any significance to the lateral drilled wellbore. Even the hydraulically induced fractures with frac fluid sand laden proppant must intersect not just the matrix in between and along two NVFs a few hundred feet away from the wellbore, but all of these NVFs away from the wellbore over the entire length of the lateral! The NVFs are the primary reservoir! Yet, they are not mapped as part of the open hole well logging operation and used in the design of completion strategy or design models. Today, such means of fracking is accomplished profusely by running casing, cementing it in place, perforating and fracking in stages ranging in length from 100′ to 600′ each, and injecting millions of gallons of water with a couple of pounds of sand proppant per gallon at maximum rates. This, would appear to be a logical process and procedure, based upon historical extraction methodology from vertical wells. However, for the shales, this classical process needs to be examined in great detail, since after the first two years the production decline curves are down to 80% or less and the ultimate estimated recoverable gas is only 20%, instead of normal 60%, as well as, much less than 20% of the millions of gallons of injected frac water is returned. These facts alone justify substantial research on all major processes associated with extracting oil and gas (“0 & G”) from shale reservoirs. This begins with identifying the truly pertinent variables with horizontal shale wells, of lateral vertical fractures (“LVFs”) and in situ stress fields, and the first step of application begins with drilling the lateral. However, in order to create data to do engineering designs before even drilling the lateral, the herein invented methodology, devices, and processes can be used in the vertical section of the vertical well drilled first down to and usually through the pay zone of interest (shale) to accurately locate it at the specific site, and before plugging back to where the heel of the curve is to begin, this herein described process needs to be executed as a part of normal well logging procedure. As step 1, with the herein used in situ stress measuring method, the stresses can be measured from a vertical plane anywhere in the remaining open hole vertical wellbore (typically a few 1,000′), in any lithology formation or stratigraphic layer for later comparison with horizontal measurements. Then following the cementing in place the vertical section of pipe and inserting the drill string with bit down to begin the horizontal lateral, and drilling it to total depth (total lateral length), the drilling tools are totally removed from the well leaving an open-hole lateral wellbore. This begins step 2 of open hole logging prior to even planning the well completion design. This includes measuring at any point or as many points along the total lateral length the in situ stresses, and along the way counting and mapping every NVFs, including uses of video cameras with LED lights positioned to look forward and backward and circumferentially along the wellbore to obtain not only their presence, but details of their structure and characterization. Such in situ stress measurements and video, and other transducer data are stored in onboard devices as well as Wi-Fi or hard-wire transmitted back to the heel of the open wellbore where it is then transmitted in real time back to the above ground logging truck. Well completion design begins immediately. There are also other pertinent variables measured simultaneously in the lateral with sensors located along the housing of the Wellbore-Reservoir-Logging-Mapping-Characterization System (“WRLMCS”) incorporating the video cameras, lights, etc. Such additional variables include: noise, velocity meters, calipers, odometers, wellbore pressure, event and observation documentation, a grid for azimuth measuring, magnetic compasses, true vertical orientation instrument, temperature, pitot tube, hardness tool, to name a few, but not limited to these variables. These aforementioned variables are capable of being deployed and measured by either autonomous vehicle or coiled tubing mounted means, including both autonomous vehicle mounted on end of tubing just to some position in the wellbore for autonomous application, or for use while attached to coiled tubing. Another unique feature of the (WRLMCS) is that it characterizes the wellbore and reservoir in real time by onboard processers and models as data are acquired, which is not performed in conventional vertical well logging, largely. because the need does not exist.

The Process of Drilling Shales that Critically Involves these Variables

This process involves both material and structural characterization, and utilization of both of the properties in engineering design as may be measured or ascertained from means described above. Consider first the structural properties of the shales and their implications pertaining to drilling. Since every NVF intersected along the lateral is the only major conduit to the wellbore, it merits full consideration as to how to protect it from any damage while drilling. The first obvious concern is loading the lateral and vertical wellbore with drilling mud to circulate cuttings back to the surface, and to facilitate well control from reservoir high gas pressures and increased gas flow each time a NVF is intersected throughout the lateral length. Fortunately, the mud compound is of chemical composition that does not degrade the shale surfaces. Therefore, this may not initially appear serious because after drilling the lateral and inserting the pipe, the wellbore is flushed with water washing away wellbore surface drilling mud, before cement is pumped. However, the process still merits further examination. When drilling with air, care is taken to drill in some pressure balanced+/−fashion to prevent gas from entering the wellbore, and to prevent shale dust size cuttings from plugging the NVFs intersecting the wellbore. However, this concept has little impact when mudding up, even if the drilling mud is lightened or aeriated, and the reasons can be quantified. Full quantification of the reasons involves both material and structural properties of the reservoir, and, the structural property of in situ stresses. Even the in situ stress field is dependent upon the material properties of the shale, which may come as a surprise to those not working specifically in this disciplinary area.

The Middle Devonian Age Marcellus Shale formed by sedimentary deposition about 385 to 390 million years ago has undergone a metamorphism history of thermo-organic, chemical, and solidification maturation processes that have resulted in a brittle, fragile, fabric of fissile nature. The most historical influential events potentially impacting the present are the tectonic, orogeny type events occurring 225 to 300 million years ago that have left structural and stress field remanents. However, the extent of those and any more recent Rome Trough related, seismic or thrust faulting events, or the 65 million years ago Yucatan Peninsula Chicxulub Asteroid, on today's in situ stress fields depends upon their material properties from the time of the impact events until today, plenty of time for stress relaxation in most materials. We must therefore, test and evaluate these mechanical, physical properties to the extent possible quantitatively, and in particular under the reservoir simulated conditions as much as possible. The elastic, ultimate strengths, viscoplastic and related properties are essential properties to design or evaluate drilling and fracking scenarios in an engineering manner. As pertains to drilling, there are two major issues of concern, first the material properties of compressive and shear strengths of the shale, as effects borehole cave-ins, and the ability of the shale to form an arch as a structure to support a borehole through it. The second effect pertains to plugging damage to the NVFs not only at the wellbore, but far away from the wellbore. These second effects are also functions of two causative mechanisms, first the reservoir material and structural properties, and second, the variables associated with both drilling and fracking. The major drilling variables associated with the structural properties of the reservoir are 1) existing in situ stress fields, and the shale properties to be determined in lab tests or preferably as herein above described. We do not know the in situ stresses, except for the vertical z direction calculated stress based upon the rule of thumb of 1 psi/ft depth, which gives 7,500 psi as a nominal value for Marcellus Shale. The lateral stresses depend upon several time-dependent variables, and largely the value of a pseudo Poisson's Ratio as determined from a single slab or in bulk cascade manner perpendicular to the bedding planes. If a Poisson's Ratio is assumed to be in the range of 0.2 to 0.35, a result of the overburden stress of 7,500 psi alone would result in a uniform lateral in situ stress ranging from 1,500 psi to 2,650 psi unilaterally. This contrasts with an approximate hydrostatic condition of 3,250 psi. Given historic values of in situ stresses in the Appalachian Basin, the Smin principal stress has a NW trend, and Smax principal stress has a NE trend, largely aligned with the NVF orientations, and with a non-hydrostatic bias symbolic of the residual effects of any recent orogenic, thrust fault or seismic activity and with differences greater than 10% in competent rocks. The Smax and Smin in the Marcellus in the region is of major importance and remains to be determined. All the above rationale and estimates for the material and structural properties are inadequate without the adequate precision and accuracy required for competent engineering designs and calculations, which led to this invention.

The second effect of plugging of the NVF as caused by drilling can be quantified by estimate based upon the density of the drilling fluid leading to hydrostatic pressure at the nominal 7,500′ depth, plus the top of wellbore circulating pressure. The major issue arises when using drilling mud of density greater than 63 lbs./ft³ which results in a hydrostatic head of 3,281 psi plus the surface circulating pressure usually greater than 1,000 psi. which, neglecting pressure drop along the wellbore, yields a pressure at the NVFs greater than 4,000 psi. The “rock” pressure of the gas coming out of the NVFs is in the range of 5,000 psi. Thus, if the drilling mud circulating pump pressure exceeds the 2,000 psi range, the wellbore pressure in excess of 5,000 psi will damage far beyond skin damage, and result in serious invasion that causes the mud to penetrate the NVFs and plug them off large distances away from the wellbore. Vibrations of the drill bit, drill stem, and drill pipe also exacerbates the mud migration process. In addition, if the imposed wellbore pressure is significantly greater than 5,000 psi and exceeds the lateral in situ stresses, this may open the NVFs and accelerate mud migration into all NVFs intersecting the full length of the wellbore, which would be a slightly catastrophic event when the pump pressure is reduced and the mud is trapped in the fractures. This is believed to be one of the principal mechanisms contributing to the 80% production decline in 2 years. At best, this appears to be a borderline, risky process that may not be receiving appropriate attention by drilling and well completion personnel, or major O & G industrial and government leaders. Once again, these above estimates of unknown accuracy are not suitable for quantitative evaluation of cause-effect relationships and advancing the technologies.

Cased-Hole Completion Consequences

The more serious issues arise when pipe is run in the hole and cement is being circulated down the pipe and back up the annulus around the outside of the pipe. If the cement density is 12 lbs/gal or greater, the hydrostatic pressure of 4,675 psi along with the circulating pump pressure greater than 2,000 psi creates a multiplicity of issues, including: 1) NVFs invasion at large distances from the wellbore due to the negative (rock pressure−wellbore pressure) difference, 2) opening of the NVFs because the imposed wellbore pressure is larger than both of the lateral in situ stresses, 3) all ultimate strengths of the shale are exceeded, and 4) the pressure may be sufficient to hydraulically fracture with cement the shale in many places with the normal imperfection small fissures and stress concentrators. When any of these 4 events occur, a highly significant cocoon develops around not just the wellbore, but between NVF planes that may extend large distances laterally from the wellbore (out to lateral spacing of 250′ each side of wellbore), and to the top and bottom of pay zone (50′). This process is simply devastating when the other 3 phenomena come into play, which appears to be highly likely for the Marcellus Shale in much of Appalachia. For the Utica and Rogersville and other deeper shales everywhere, all these issues pose even more serious problems. In fact, the gas reservoir comprised of NVF systems is in essence honey-comb like entombed and limited only to the access volume created by a very few hydraulic fractures that intersect the adjacent 2 NVFs and connect to the perforations. This could be a very plausible explanation for the 80% decline in production in 2 years and recovery of only 20% of the reserves in place. This implies that perhaps, as much as, or more than 50% of the reservoirs of valuable energy and chemical feedstock resources is cocooned or entombed forever, to never be economically viable for recovery. This scenario is bad enough for the Marcellus Shale, and demands urgent attention and improved extraction processes to be used around the world. The other deeper shales may also have lower strength properties in some regions that will absolutely dictate other extraction processes. The larger overburden created in situ stresses will probably render conventional methodology very inefficient with devastating recovery efficiency and with even steeper decline curves. Thus, the drilling processes as practiced need to be reevaluated, and the current practices of cased hole, perforate and hydraulically fracture processes need to cease, and be replaced with more efficient recovery processes. At this time, it would appear that the basic starting point is “balanced” air drilling and open hole completions, which averts known damages, and enables creativity, innovation and new methodologies and technologies to be explored. In particular, new safety measures, perfected hardware, and well control processes all need immediate attention if recovery efficiency is to be improved. These traumatic issues further reinforce the urgent need for accurate reservoir data as can be obtained with the above devices, methodologies, and processes. The fact that every day 1000s of wells are being drilled everywhere around the world using this technology and methodology further validates the urgency for the above described invention.

World-Wide Consequences

In perspective, and according to EIA the U. S. is fourth (665 tcf) in the world in recoverable shale gas resources (almost half of China's with 1,115 tcf), and second behind Russia in recoverable shale oil resources. If we take into consideration what the world impact is if only 8% oil and 20% gas of the world's EIA estimated recoverable resources stated above are, in reality, this places a quantitative measure of urgency on the invention described. So, what can be done to improve extraction process recovery efficiency along with eliminating so many other serious issues, such as less than expected economic investment returns, huge volumes of water consumption that is rendered forever unavailable for use on earth, pollution risks, disposal costs and other implications, as well as, permanently entombing about half of earth's valuable oil and natural gas resources? More specifically, what data are needed to create new, innovative completion technologies and improve process design efficiency? Answer: The data generated from the above herein described variables and measurements as obtained from the herein described system.

The Deployed System (WRLMCS) Overview

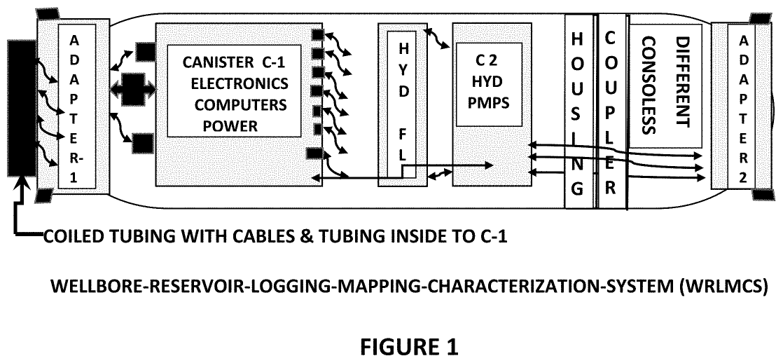

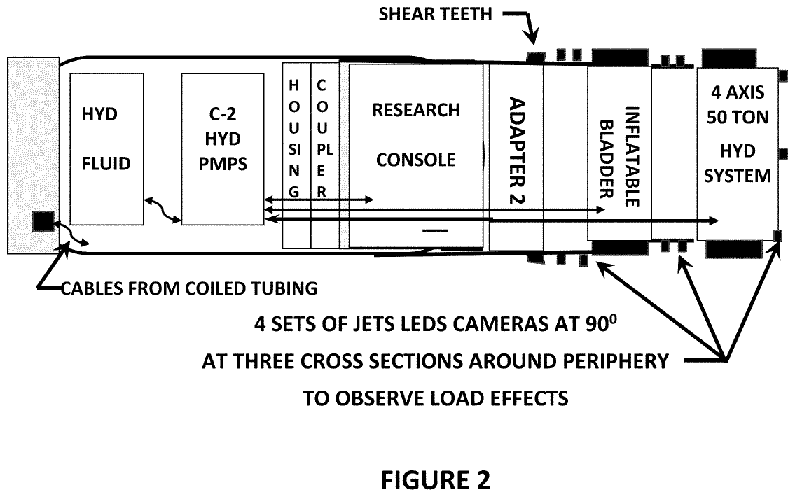

The complexity of sensors, transducers, LED lights, cameras, instruments, signal processing, data acquisition and storage systems, pressure transducers, chips, microprocessors, and mechanisms, etc. are concentrated in a circular cylinder canister, see FIG. 1, with various configurations and modules to constitute different system models, so as to allow specific objectives to be achieved in different subterranean environments in order to meet the in situ stresses and NVFs system characterization requirements. Some instruments are Plug-and-Play. Several of the independently measured variables will also be used in different combinations to synthesize contexts and eliminate ambiguities or misinterpretations of certain data. For example, light reflections from mini-fracture surfaces, or “breakouts” will be used with magnetic compass, caliper, and (WRLMCS) to correlate implications of in situ stress field orientations and magnitudes suitable for incorporation into analytical or numerical models, as well as, interpretation of causative effects, and (WRLMCS) data will be correlated with caliper data, etc. In addition to the measured variable transducers, some of the instruments require support services mechanisms, such as a compressed gas storage tank and controls, and hydraulic actuators to inflate and deflate a bladder, battery and electric actuated hydraulic valves, as shown in FIG. 2, part of the in situ stress subsystem. Some variables essential to comprehensively characterize the reservoir include such transducers and instruments as video cameras and recorders, LED lights, noise, velocity meters, calipers, odometers, event and observation documentation, a grid for azimuth measuring, magnetic compasses, true vertical orientation instrument, temperature, pitot tube, hardness tool, to name a few, but not limited to these variables being measured and the needed instrumentation.

Rationale and Justification for the Deployed System

Oil and gas well drilling and completion technology evolved and matured for vertical wells over 100 years, and especially the last 40 years up to 2,000, and then directional drilling began to mature and gain dominant utilization by 2010. Since then, it appears that drilling and completion technology has had only modest improvements in the basic processes. The mindsets of gaining access to the reservoir, which was the challenge for vertical wells, does not apply today. The laterals now are IN the reservoir, but the brute force utilized for vertical wells, and the type of data needed for vertical wells throughout O & G industry history is not relevant to the laterals being drilled in the Marcellus and Utica Shales today, and being IN the reservoir. The entire wellbore actually being in and through the reservoir implicates need for different mindsets, different data sets, and different strategies, dealing with different geometry and structures, requiring different academic disciplines and approaches to both drilling and completion, as well as, economic models for funding and return on investment. In summary, the entire model, from economic to drilling and completion, of drilling horizontal wells below 6,000′ needs to change to achieve sustainability. Especially open hole technology has not evolved, and is far removed from its potential.

The Technology needs are different in a variety of ways. Embodiments of this System include AI (artificial intelligence), IT (information technology), and robotics as an integrated system as a means of efficiently and effectively characterizing a horizontal wellbore and the reservoir through which it is drilled. AI, IT and robotics are used in conjunction with measuring the now relevant variables in an open hole horizontal lateral O & G borehole, acquiring and transporting the data in a useful manner, some on-board data reduction and utilization, and then using it in planning and executing new, innovative well completion methodologies based upon such data that are fundamental and feasible, yet, nonexistent. The current entire structure is obsolete. Due to the rush to drill and produce, spur the economy, lack of proper incentives, and lack of the broad multidisciplinary in-unison research participation, it has not happened. However, this herein invented device, methodology, and process (System), represents the next achievable evolutionary phase.

In order to make the herein System more comprehensive with broader applications, it is designed to provide sufficient information to facilitate a new type of investment strategy that could accommodate new completion methodologies with much higher percentage of ultimate recovery of the natural resources, but perhaps with a lesser rate of return on investment in the short 2-year term. Economic models used today are very quick pay back (ROI) in 2 to 4 years, but with 80% depletion in the second year, and less than 20% ultimate gas recovery, they are failing with broad current and future implications! This model works for drilling companies, well logging and completion companies, and some investors, so what is the problem, since it serves many of the incentives of most parties of the industry? This current model is even positively impacting our economy with employment and tax revenues for otherwise poor states and communities at the moment! Unfortunately, the unanticipated 80% decline in 2 years has now soured Wall Street investors since for several years they have been losing money. The worst, and more-subtle problem, is that current methodology is destroying and rendering irrecoverable forever, over 50% of the reserves in place. There needs to be an alternative conservative model that says, get pay back over 5 to 10 years, as in real estate, but provide a high monthly yield for 50 to 75 years and recover at least 60% or much more, maybe up to 80%. After starting the drilling of a horizontal wellbore at some prime point within the reservoir, and being in the middle of the 10K′ to 20K′ long reservoir with dimensions of only 50′ high by up to 250′ on both sides of the wellbore it is grossly unacceptable for such inefficiencies! The current technical and economic models are reflective of unintentional, but gross extravaganza, and wasteful practices, not only in the U. S., but around the world, since the same completion methods and equipment (U. S.) are used around the world! Rationale for the technology and methodology embodied herein is intended to solve this dilemma, by utilizing open hole completions. The focus herein is also on open hole technology because only it offers opportunity to circumvent the unavoidable reservoir damages using any cased-hole methodology. Since our precious billion dollar reserves are being permanently wasted daily, there is great urgency in developing and implementing this technology ASAP.

Specific System Features (WRLMCS)

FIG. 1 illustrates the larger major components of the Wellbore-Reservoir-Logging-Mapping-Characterization System (WRLMCS) This comprehensive System is intended to perform the basic functions as needed in standard logging of wellbores in order to plan well completion designs. In addition, for lateral wellbores, all aspects of the natural vertical fracture system (NVF's) and any other abnormal structural features need to be discovered, recorded and assessed prior to planning, or attempting to conduct a well completion process. Thus, the NVFs are mapped in a variety of ways to fully characterize them as much as possible in order to assess all of their implications in a particular lateral wellbore. This is unique and contrary to the practices needed for vertical well logging. Running a set of logging tools in a 7500′ deep and 10,000′ long lateral is an expensive, risky and time consuming process, so if there is any opportunity to further define questionable conditions discovered during a survey, then the system being used should be able to accommodate that need to the degree reasonably feasible. Since in situ stress fields are a top priority variable along with wellbore stability, it is desirable to fully characterize these variables at the same time as part of a logging and mapping process. Therefore, the basic capability to perform wellbore stability assessments and obtain in situ stress related additional data at the same time is built into the WRLMCS to use as needed.

The (WRLMCS) Housing

As part of NVF and reservoir characterization of the many manifestations in this application, temperature, noise, velocity, and a wall resistivity log are used in conjunction with video cameras to characterize the nature of the NVFs, including the angle with which they intersect the wellbore (FIG. 2). Such additional variables include: noise, velocity meters, calipers, odometers, wellbore pressure, event and observation documentation, a grid for azimuth measuring, magnetic compasses, true vertical orientation instrument, temperature, pitot tube, hardness tool, to name a few, but not limited to these variables. The magnetic compass is mounted outside the housing on the front end in view of a camera with a vertical gravity centering device. These sensors and transducers are inserted through strategically located ports all along the thick wall steel housing of the WRLMCS (FIG. 1) with strategic orientations, and in some cases 4 or more at right angles in any one cross section of the housing (FIG. 2). Such ports are placed at different locations along the length of the WRLMCS both for operational purposes, as well as, research and characterization purposes. It should be noted that usually it is the intent to drill the wellbore using a transparent gas with no liquids in the wellbore while drilling the lateral, which enhances the WRLMCS effectiveness. Also, the thick wall WRLMCS housing inside and outside is exposed to the pressure of the wellbore, with restricted or chocked flow, which is also optionally the pressure within the coiled tubing in that they are connected at the end of the hydraulic cylinder at the front end of the WRLMCS on most occasions, such that injection from above ground into the coiled tubing would go toward pressurizing the wellbore, and supplying air to jets, or reversely, continuously measuring/monitoring or bleeding off the wellbore pressure. In order to accommodate certain experimental research objectives, different modules are needed, to perform specific functions. Thus, an internal insert-based coupler with high shear strength pins as illustrated in FIG. 1 is used to unobtrusively couple the various modules on the front or opposite end of the coiled tubing. Also, as illustrated in FIG. 1, a specially designed adapter transition piece is used to couple the WRLMCS housing to the coiled tubing. This special adapter serves not only as a mechanical transition adapter from larger diameter housing pipe to lower diameter coiled tubing, but also as a positioner for cameras, LED lights, and small diameter holes for air pressure jets to scavenge the camera lens with air from the coiled tubing. These ports are arranged around the periphery of the adapter.

Miscellaneous Housing Features

Front and rear wear centralizing plates with shear teeth on outer periphery are further embodiments of the mechanical transition adapter described above. Depending upon the diameter of the open hole wellbore drilled with different types and diameter bits, an adapter of different configurations is applied to the front and rear, and optionally in the middle, of the housing. The purpose of the shearing teeth is to shear off shale partial breakouts protruding into the wellbore to avoid wedging and hanging up of the housing and requiring extreme forces on the coiled tubing with potential dire consequences. Depending on the shale fabric, the shear teeth on the coiled tubing end as illustrated in FIG. 1, may be replaced with a smooth sloped glide adapter. Trade offs on the wall thickness are made depending upon the particular logging situation. If weight is not an issue, then thick wall tubing, schedule 80 or heavier is used to accommodate the use of pipe threaded ports that may be used for some transducers, etc., and tight, hazardous wellbores. The length of the housing may also vary depending upon the mission, and typically range from 12 to 30′, which may occur by plug in console module sections, or a single length of pipe. The front and rear ends of the housing also have a boss in the attaching and terminating adapters for cameras, LEDs, and small nominal ⅛″ jet holes for both scavenging dust off cameras, and clearing debris. The jets are supplied with air or gas from the top of coiled tubing above ground connected with an optional valve connecting to a compressor.

Electronic-Instrumentation Subsystem Canister 1 (C-1)

Also illustrated in FIG. 1, there are two hermetically sealed canisters, the first Canister (C-1), is capable of withstanding up to at least 10,000 psi pressure with a variety of electrical cable hermetic seal throughputs, also capable of withstanding 10,000 psi. These throughputs of shielded conductors are for power supply and signal transmission to/from sensors, signal conditioners, data storage, processing and transmission devices, power supplies, and control devices outside C-1, and microprocessors for system modeling in real time as data become available. Such processed data may be used in real time process control or “on-the-fly” decision making. Provisions include power and communication cables optional from the cables inside the coiled tubing (CT) to above ground, or as originate from inside C-1.

Hydraulic Subsystem Canister (C-2)

Canister 2 (C-2) is also a 10,000 psi canister with hydraulic and electrical throughputs that facilitates signals from C-1 or CT to be transmitted to a small hydraulic fluid reservoir and an electric, small-rate, small volume, high-pressure hydraulic pumps to actuate an optional choice of an inflatable bladder or a hydraulic cylinder (jack) with specially designed radially distributed shoes to apply a prescribed stress against the open wellbore wall to ascertain the in situ stresses and stability of the shale in proximity to the wellbore wall. (FIG. 2) The self contained hydraulic system inside C-2, and to and including the jack cylinder and hoses are capable of 15,000 psi.

Video Wellbore and Process Surveillance Subsystem

The multichannel, multi-camera system serves a variety of purposes in addition to NVF characterization. Again, there are ports in the housing and housing adapters 1 and 2, for forward-looking, side-wall, and rear-looking cameras to look for conditions and potential events impacting the decisions, safety, and effectiveness of the WRLMCS operation. Also cameras are provided to monitor the wellbore adjacent to and including the inflated bladder and the hydraulic jack applied stresses on the wellbore wall as a means of data correlation, characterization, and wellbore stability risk assessment. All of these processes are different from vertical wells and necessitated by the lateral horizontal borehole through the reservoir as compared to a vertical wellbore and its characterization. In a horizontal wellbore, 3-D sensing and modeling or characterization are far more critical and far more feasible than from a vertical wellbore.

Autonomous Module

Certain wellbore conditions and exploration purposes demand for best opportunities an autonomous expedition from either the heel of the wellbore, or any particular position along the wellbore where the WRLMCS autonomous module (AM) may be launched. The AM has different features, is more expensive and has other attributes that results in it not being associated with the design for more routine logging, mapping, and characterization purposes, although the module is available in the field vehicle at the job site pad should it be needed. The AM is of shorter and lighter design, and of smaller diameter, to facilitate better wellbore mobility with less risk in order to gain some specific data. In other respects, it has similar features as described above.

The power train in the AM is comprised of flexible drive shafts powered by individual, high torque, low speed, synchronized electric battery powered motors. The individual flexible shafts drive retractable wheels positioned at front, center and rear of the housing, and at each cross section there are four individually powered treaded wheels to grip the wellbore walls with appropriate hydraulically applied force to insure traction in a circular, irregular, wellbore terrain. The AM possesses Wi-Fi and has forward and reverse capability as provided by D.C motors and controls. The AM is maintained within Wi-Fi range of the end of the coiled tubing in which the matching module base station is located. The primary mission is associated with gathering data pertinent to in situ stress field measurements, implications and applications, in particular, where the conventional WRLMCS cannot or should not go.

What is claimed:

1. A horizontal wellbore and reservoir system for logging, mapping and characterizing data so to acquire real reservoir in situ condition data for engineering application in directional drilling and new well completions, the system comprising:
a housing;
a plurality of sensors and transducers;
a plurality of cameras for capturing image data:
a magnetic compass;
a plurality of LEDs;
a first canister;
a second canister;
at least one processing controller;
a power unit;
wherein the housing comprises coiled tubing connected at the end of a hydraulic cylinder, such that injection form the above ground into the coiled tubing would go toward pressurizing the wellbore and supplying air to jets;
wherein the housing comprises a first adapter which is a mechanical transition adapter from larger diameter housing pipe to lower diameter coiled tubing:
wherein the first adapter comprises the plurality of cameras, LED lights and ports for the jets;
the jets are used to scavenge the plurality of cameras with air from the coiled tubing;
the magnetic compass is mounted outside the housing on the front end in view of the plurality of cameras and further comprises a vertical gravity centering unit;
the plurality of sensors and transducers acquire at least temperature data, noise data, velocity data and wall resistivity log data;
wherein the plurality of sensors and transducers are able to acquire and measure data including noise, velocity meters, calipers, odometers, wellbore pressure, event and observation documentation, a grid for azimuth measuring, magnetic compasses, true vertical orientation instruments, temperature pitot tube and hardness tool;
wherein the processing controller is able to characterize a natural vertical fracture including the angle with which they intersect a wellbore based upon the acquired temperature data, noise data, velocity data, wall resistivity log data and image data.

2. The system of claim 1, wherein the first adapter further comprises:
a front wear centralizing plate with shear teeth on the outer periphery; and
a rear wear centralizing plate with shear teeth on the outer periphery.

3. The system of claim 1, further comprising:
a first hermetically sealed canister capable of withstanding a minimum of 10,000 psi pressure;
wherein the first hermetically sealed canister comprises a plurality of electrical cable hermetic seal throughputs of shielded conductors for power supply and signal transmission.

4. The system of claim 3, wherein the throughputs of shielded conductors for power supply and signal transmission is used for transmission to/from sensors, signal conditioners, data storage, processing and transmission devices, power supplies and control devices outside of the first hermetically sealed canister.

5. The system of claim 1, further comprising:
a second hermetically sealed canister capable of withstanding a minimum of 10,000 psi pressure;
the second hermetically sealed canister comprising hydraulic and electrical throughputs that facilitates signals to be transmitted to a small hydraulic fluid reservoir and an electric high-pressure hydraulic pump to actuate an optional choice of an inflatable bladder of hydraulic cylinder.

6. The system of claim 5, wherein the plurality of cameras are used to monitor the wellbore adjacent to and including the inflated bladder and the hydraulic jack applied stresses on the wellbore wall.

7. The system of claim 1, further comprising:
a communication unit for external communication of data.

8. The system of claim 1, wherein pressure, force, and displacement transducers enable a calculation of elasticity constitutive coefficients under in situ conditions.

9. The system of claim 1, wherein pressure, force, and displacement transducers and cameras provide data needed to calculate, measure and confirm a von Mises stress failure material property under in situ reservoir conditions.

10. The system of claim 1, wherein pressure, force, and displacement transducers and cameras provide data necessary to construct reservoir simulation models, such as, for hydraulic fracturing and other well completion methods.

11. The system of claim 1, wherein pressure, force, and displacement transducers and cameras provide data to determine the in situ properties of reservoir rocks to classify as brittle or malleable materials.

12. The system of claim 1, wherein pressure, force, and displacement transducers and cameras allow determination of magnitudes and directions of principal in situ stresses.

13. The system of claim 10, wherein from data collected, reservoir simulation models can be created to be used to design and control in real time well stimulation processes.

14. The system of claim 1, wherein 4-wire electrical resistivity conductors in a plane spaced at 90 degrees that scrape the wellbore wall as the system traverses an entire length, along with the odometer and coiled tubing measurements creates a 3-D map of the natural vertical fractures throughout wellbore length.

15. The method comprising the system in claim 6 of determining in situ directional stress fields.

16. The method comprising the system in claim 10 of determining in situ directional stress fields.

17. The method comprising the system in claim 6 to determine the elasticity constitutive coefficients under in situ conditions.
